(19) United States
(12) Patent Application Publication
(10) Pub. No.: US 2026/0307189 A1
(43) Pub. Date: Oct. 8, 2026

(54) CLAMPING DEVICE FOR A MACHINING CENTER AND MACHINING CENTER

(71) Applicant: MG Beteiligungsgesellschaft mbH, Geislingen/Steige (DE)

(72) Inventor: Magnus GRÜNER, Geislingen/Steige (DE)

(21) Appl. No.: 19/636,498

(22) Filed: Apr. 1, 2026

(30) Foreign Application Priority Data
Apr. 2, 2025 (EP) 25168040

(51) Int. Cl. B23Q 3/06; B23Q 3/10

(52) U.S. Cl. CPC B23Q 3/06; B23Q 3/103

(57) ABSTRACT

A clamping device for a machining center for the mechanical machining of workpieces, including a workpiece pallet for coupling with the machining center, such that the clamping device is rotatable about a first axis of rotation in a coupled state of use. The clamping device has a first clamping unit receiving device and a second clamping unit receiving device which are connected to the workpiece pallet, in which the first clamping unit receiving device has a first receiving housing and a first rotary table received in the first receiving housing, to which a first clamping unit for receiving and clamping a first workpiece can be fastened, in which the second clamping unit receiving device has a second receiving housing and a second rotary table received in the second receiving housing, to which a second clamping unit for receiving and clamping a second workpiece can be fastened.

### CROSS REFERENCE TO RELATED APLICATIONS

This application claims priority to European Patent Application No. 25168040.1 filed on Apr. 2, 2025, which is incorporated reference.

### BACKGROUND

The invention relates to a clamping device for a machining center and a machining center.

The object of the present invention is to increase the throughput of workpieces to be machined with a machining center and at the same time to ensure a high machining quality.

### SUMMARY

The object is achieved by a clamping device and a machining center as discussed herein.

A clamping device according to the invention for a machining center for the mechanical machining of workpieces has a workpiece pallet for coupling with the machining center, such that the clamping device is rotatable about a first axis of rotation in a coupled state of use, and wherein the clamping device has a first clamping unit receiving device and a second clamping unit receiving device which are connected to the workpiece pallet, wherein the first clamping unit receiving device has a first receiving housing and a first rotary table received in the first receiving housing, to which a first clamping unit for receiving and clamping a first workpiece can be fastened, wherein the second clamping unit receiving device has a second receiving housing and a second rotary table received in the second receiving housing, to which a second clamping unit for receiving and clamping a second workpiece can be fastened, wherein the clamping device has a rotary table drive which is adapted to rotate the first rotary table about a second axis of rotation and to rotate the second rotary table about a third axis of rotation, wherein the first clamping unit receiving device has a first blocking device with a first coupling element fixed to the first clamping unit receiving device and a first blocking element movable relative to the first coupling element, wherein the first rotary table can be moved by means of a first engagement movement to be carried out with the first blocking element into a first blocking position in which the first rotary table is non-rotatably coupled to the first receiving housing with respect to the second axis of rotation, and by means of a first disengagement movement to be carried out with the first blocking element into a first release position in which the first rotary table is rotatable relative to the first receiving housing with respect to the second axis of rotation, wherein the second clamping unit receiving device has a second blocking device with a second coupling element fixed to the second clamping unit receiving device and a second blocking element movable relative to the second coupling element, wherein the second rotary table can be moved by means of a second engagement movement to be carried out with the second blocking element into a second blocking position in which the second rotary table is non-rotatably coupled to the second receiving housing with respect to the third axis of rotation, and by means of a second disengagement movement to be carried out with the second blocking element into a second release position in which the second rotary table is rotatable relative to the second receiving housing with respect to the third axis of rotation.

A machining center is a machine or system with which workpieces can be mechanically machined. The mechanical machining of workpieces is understood to mean forming, separating, joining, coating and/or changing the material properties of the workpiece. Purely by way of example, the workpiece can be machined by cutting in the machining center.

The workpiece pallet serves to couple the clamping device with the machining center. The coupling comprises on the one hand a mechanical connection of the workpiece pallet with the machining center. On the other hand, the coupling comprises a functional connection of the workpiece pallet with the machining center, for example, in order to transmit drive energy and/or drive signals from the machining center to the clamping device, in particular to rotate the clamping device about the first axis of rotation. In the state of use, the clamping device is coupled to the machining center via the workpiece pallet.

The workpiece pallet further serves to connect the first clamping unit receiving device and the second clamping unit receiving device with the machining center. Preferably, the workpiece pallet, the first clamping unit receiving device and the second clamping unit receiving device are fixedly connected to one another, in particular screwed to one another. Furthermore, it is preferred that the first clamping unit receiving device adjoins the workpiece pallet and the second clamping unit receiving device adjoins the first clamping unit receiving device. It is further preferred that the aforementioned connection is made via the first receiving housing and the second receiving housing, that is to say that the first receiving housing and the second receiving housing are connected to the workpiece pallet.

Components whose designation includes the numeral "first" form a first functional unit. Such components are, for example, the first clamping unit receiving device, the first receiving housing, the first rotary table, etc. Components whose designation includes the numeral "second" form a second functional unit. Such components are, for example, the second clamping unit receiving device, the second receiving housing, the second rotary table, etc. Preferably, components whose designation differs only by the numeral "first" and "second" are of the same design. For example, the first receiving housing and the second receiving housing are of the same design. For reasons of better readability, the numerals "first" and "second" are sometimes omitted in the following explanations, whereby the respective explanations apply to the relevant "first" component and/or the relevant "second" component. For example, explanations with reference to the receiving housing apply to the first receiving housing and/or the second receiving housing.

The rotary table received in the receiving housing is at least partially surrounded by the receiving housing. Preferably, the part of the rotary table to which the clamping unit can be fastened projects out of the receiving housing.

The clamping unit has at least one clamping element which is movable between a release position and a clamping position in which the workpiece to be machined is clamped. Preferably, the clamping unit is fixed. It is further preferred that the clamping unit is specifically designed for the workpiece to be clamped and machined with the machining center. This can be achieved in particular in that an outer geometry and/or arrangement of the clamping element corresponds to an outer geometry of the workpiece. It is further preferred that the clamping unit is designed to be exchangeable, so that depending on the workpiece to be machined, a respectively suitable clamping unit can be fastened to the rotary table. By providing a first rotary table and a second rotary table, two clamping units - the first clamping unit and the second clamping unit - can be used simultaneously with a single clamping device according to the invention and thus two workpieces - the first workpiece and the second workpiece - can be clamped simultaneously. In this way, a high throughput of workpieces to be machined with the machining center can be achieved.

Preferably, the second axis of rotation and the third axis of rotation are aligned substantially horizontally in the position of use. It is further preferred that the second axis of rotation is aligned parallel to the third axis of rotation. If the clamping unit is fastened to the rotary table and the workpiece is clamped with the clamping unit, the workpiece can be rotated about the second axis of rotation or third axis of rotation in the same way by rotation of the rotary table about the second axis of rotation or third axis of rotation. In this way, the workpiece can be rotatably aligned in the desired manner with respect to a machining tool device of the machining center, which may be movable only linearly, so that different outer sides of the workpiece can be mechanically machined and/or the workpiece can be machined at different machining angles.

In order to prevent a workpiece to be machined from rotating undesirably during its mechanical machining, as a result of which its machining cannot be carried out as planned, it is provided according to the invention that the blocking device can be moved with the rotary table into the blocking position by means of the engagement movement. In the blocking position, the rotary table is non-rotatably coupled to the receiving housing with respect to the second axis of rotation or third axis of rotation. This can ensure a high quality of machining. In the release position, which can be reached by means of the disengagement movement, the rotary table is rotatable relative to the receiving housing with respect to the second axis of rotation or third axis of rotation. With the coupling element and the blocking element, two mutually movable elements of the blocking device are provided with which the engagement movement and the disengagement movement can be carried out.

Advantageous further developments are the subject of the sub-claims.

Preferably, in at least one of the blocking devices, the coupling element is designed as an outer coupling element fixedly connected to the receiving housing, and at least one of the blocking devices has an inner coupling element fixedly connected to the first rotary table or the second rotary table, wherein in the blocking position the outer coupling element is positively connected to the inner coupling element with respect to a rotation about the second axis of rotation or the third axis of rotation. Preferably, the prefixes "outer" and "inner" refer to an arrangement of the respective coupling element with respect to each other in a plane spanned perpendicular to the axis of rotation. Accordingly, the outer coupling element preferably has a larger extension in the plane running perpendicular to the axis of rotation than the inner coupling element, in particular an outer envelope curve enveloping an outer geometry of the outer coupling element has a larger diameter than an inner envelope curve of the inner coupling element enveloping an outer geometry of the inner coupling element. It is further preferred that the outer coupling element encloses the inner coupling element. It is further preferred that the outer coupling element and the inner coupling element are arranged concentrically, in particular the outer coupling element and the inner coupling element have the same center point.

Preferably, the outer coupling element has an external tooth profile and the inner coupling element has an internal tooth profile which is in engagement with the external tooth profile in the blocking position. The external tooth profile and the internal tooth profile each have a plurality of teeth. The internal tooth profile can be in direct engagement with the external tooth profile, so that tooth flanks of the internal tooth profile bear directly against tooth flanks of the external tooth profile. Alternatively, the internal tooth profile can be in indirect engagement with the external tooth profile. In particular, the blocking element is arranged between the internal tooth profile and the external tooth profile, so that tooth flanks of the internal tooth profile bear against the blocking element and the blocking element in turn bears against tooth flanks of the external tooth profile.

Preferably, the external tooth profile and the internal tooth profile are each designed as an axial toothing. Accordingly, the external tooth profile and the internal tooth profile are each formed on a face of the outer coupling element and the inner coupling element. The axial toothings are also referred to as face-side toothings. Preferably, the external tooth profile and the internal tooth profile are aligned substantially parallel to the second axis of rotation or third axis of rotation, wherein a tooth direction extending from a root circle of the external tooth profile or internal tooth profile to a tip circle of the external tooth profile or internal tooth profile extends substantially parallel to the second axis of rotation or third axis of rotation.

Preferably, in at least one of the blocking devices, the blocking element has a first bridge tooth profile, in particular designed as an axial toothing, which rests in a form-fitting manner on the external tooth profile in the blocking position, and a second bridge tooth profile, in particular designed as an axial toothing, which rests in a form-fitting manner on the internal tooth profile in the blocking position, wherein the blocking element is adapted to carry out the engagement movement and the disengagement movement along a disengagement axis, in particular aligned parallel to the second axis of rotation or third axis of rotation. Thus, a total of two tooth profile pairs are provided for a blocking device, namely the external tooth profile and the first bridge tooth profile as the first pair and the internal tooth profile and the second bridge tooth profile as the second pair. In the blocking position, the two tooth profile pairs are simultaneously in engagement. In the release position, the two tooth profile pairs are simultaneously out of engagement. In particular, the first bridge tooth profile and the second bridge tooth profile are aligned oppositely to the external tooth profile and the internal tooth profile. In this way, with the engagement movement the blocking element can be moved towards the outer coupling element and the inner coupling element and with the disengagement movement the blocking element can be moved away from the outer coupling element and the inner coupling element.

Furthermore, it is preferable that the outer coupling element, the inner coupling element and the blocking element are each of ring-like design. A ring-like design means that the outer coupling element, the inner coupling element and the blocking element can each be designed at least as a ring segment or as a closed ring.

Preferably, the external tooth profile and the first bridge tooth profile as well as the internal tooth profile and the second bridge tooth profile each form a mating toothing, preferably a serration, particularly preferably a face serration. A mating toothing is a multiple driver connection in which torque is transmitted by the tooth flanks. A serration is a special mating toothing in which the individual tooth profiles have pointed teeth. A face serration is a special serration in which an axially effective, face-side toothing is present. In particular, the external tooth profile and the first bridge tooth profile as well as the internal tooth profile and the second bridge tooth profile each form a Hirth coupling.

Preferably, at least one of the blocking devices has an adjusting device which has a piston element connected to the blocking element and received in a cylinder, wherein the adjusting device is designed to act hydraulically. The piston element fluidically separates a first pressure chamber from a second pressure chamber in an interior of the cylinder. For the aforementioned fluidic separation, a seal is in particular fixed to the piston element. If a hydraulic fluid is introduced into one of the pressure chambers, the pressure in this pressure chamber rises, whereby the piston element is moved in the direction of the other pressure chamber. The introduction of hydraulic fluid into a pressure chamber is therefore also referred to as pressurizing this pressure chamber. If a pressure chamber is pressurized, the volume of the respective pressure chamber increases. In this respect, by pressurizing a pressure chamber, the piston element can be moved in the cylinder and thus the blocking element connected to the piston element can be moved in the same way. In particular, the blocking element is fixed to a face of the piston element, in particular arranged at the end with respect to the second axis of rotation or third axis of rotation.

If at least one axial toothing is provided, it is advantageous for the transmission or dissipation of torque if elements of the blocking device are pressed against each other, in particular if the blocking element is pressed against the outer coupling element and against the inner coupling element. This can prevent the elements of the blocking device from being rotated against each other, despite the fact that the rotary table is in the blocking position, whereby the rotary table is undesirably rotated. The aforementioned pressing is achieved in particular in that the relevant pressure chamber is permanently pressurized in the blocking position.

It is further preferred that the cylinder is at least partially formed by the outer coupling element. Preferably, the cylinder is further formed by an intermediate ring fixed between the outer coupling element and the receiving housing and two spaced-apart end sections of the piston element. Between the two end sections of the piston element, a central section of the piston element projects in the radial direction into the cylinder interior. This central section forms, in functional terms, the actual piston.

Preferably, at least one of the blocking devices has a play limiting device which limits a play between the outer coupling element and the blocking element in the release position with respect to a rotation about the second axis of rotation or third axis of rotation. This can prevent the blocking element from being freely rotatable in the release position with respect to the second axis of rotation or third axis of rotation. With such a free rotatability, the risk would result that during the engagement movement, tooth tips of the first bridge tooth profile strike tooth tips of the external tooth profile and/or tooth tips of the second bridge tooth profile strike tooth tips of the internal tooth profile. If the aforementioned tooth tips strike each other in a corresponding manner, there is a risk that the blocking position cannot be reliably reached with the engagement movement.

The play limiting device is preferably adapted to limit a play between the outer coupling element and the blocking element in the release position with respect to a rotation about the second axis of rotation or third axis of rotation in such a way that with the engagement movement, tooth tips of the first bridge tooth profile reliably slide between tooth tips of the external tooth profile and tooth tips of the second bridge tooth profile slide between tooth tips of the internal tooth profile and thereby prevent individual tooth tips of the first bridge tooth profile from being opposite individual tooth tips of the external tooth profile and/or individual tooth tips of the second bridge tooth profile from being opposite individual tooth tips of the internal tooth profile along a single tooth direction aligned parallel to the first axis of rotation or second axis of rotation.

Preferably, the play limiting device has a limiting pin, in particular fastened to the outer coupling element, and a pin holder, in particular provided on the blocking element, wherein a clearance fit is formed between the limiting pin and the pin holder, wherein the limiting pin is received in the pin holder when the rotary table is in the release position. The limiting pin is preferably cylindrical in design. Furthermore, the pin holder is preferably cylindrical in design. It is further preferred that the limiting pin is also received in the pin holder when the rotary table is in the blocking position.

Preferably, the rotary table drive has a first drive shaft designed for the rotational drive of the first rotary table and a second drive shaft designed for the rotational drive of the second rotary table. Accordingly, a separate drive shaft is provided for each rotary table. This can simplify the assembly of the clamping device.

It is further preferred that the first drive shaft is connected to the second drive shaft, in particular by means of a coupling. The coupling is preferably designed as a bellows coupling. With the bellows coupling, an axial offset between the first drive shaft and the second drive shaft can be compensated. In this way, a larger tolerance can be used in manufacturing with regard to an axial distance between the first drive shaft and the second drive shaft, which simplifies the manufacturing of the clamping device.

Preferably, at least one of the drive shafts has a worm gear section, wherein the rotary table has on a radial outer surface a worm gear segment which is in engagement with the worm gear section. In this way, the respective drive shaft can be rotated about a drive shaft longitudinal axis which is aligned perpendicular to the second axis of rotation or third axis of rotation in order to generate a rotation of the rotary table about the second axis of rotation or third axis of rotation.

Preferably, at least one of the worm gear sections has a duplex toothing, wherein at least one spacer ring is arranged on at least one receiving housing in order to adjust an axial position of the drive shaft with respect to the receiving housing. In a duplex toothing, a module of tooth flanks of the worm gear section changes along the drive shaft longitudinal axis, in particular continuously. In this way, the tooth width of the individual teeth of the worm gear section changes along the drive shaft longitudinal axis. Depending on the engagement position between the worm gear section and the worm gear segment, a differently pronounced play results between the worm gear section and the worm gear segment. By offsetting the drive shaft and the rotary table relative to each other with respect to the drive shaft longitudinal axis, the aforementioned play can be adjusted.

Preferably, the play between the worm gear section and the worm gear segment is adjusted by offsetting the drive shaft along the drive shaft longitudinal axis, i.e. axially relative to the receiving housing. By providing different spacer rings, which in the state of use have different extensions with respect to the drive shaft longitudinal axis, a specific play between the worm gear section and the worm gear segment can be fixed.

Preferably, in the position of use, tooth flanks of the external tooth profile rest on tooth flanks of the first bridge tooth profile and tooth flanks of the internal tooth profile rest on tooth flanks of the second bridge tooth profile. It is further preferred that the respective tooth profiles are designed in such a way that a play with respect to a rotation about the second axis of rotation or third axis of rotation is minimized. As a result, with the engagement movement, if the inner coupling element is not exactly aligned with the blocking element or outer coupling element, tooth flanks of the inner tooth profile slide on tooth flanks of the second bridge tooth profile in such a way that the inner coupling element is slightly rotated with respect to the second axis of rotation or third axis of rotation. Depending on the rotational position of the inner coupling element, which is predetermined by a corresponding rotational position of the rotary table, the subsequent rotation of the rotary table can take place in two different directions of rotation, namely on the one hand clockwise and on the other hand counter-clockwise.

By the subsequent rotation of the rotary table, the worm gear segment is also moved relative to the worm gear section. Here, there is a risk that tooth flanks of the worm gear segment are pressed against tooth flanks of the worm gear section, whereby a load directed along the drive shaft longitudinal axis acts on the drive shaft. This load can on the one hand lead to the fact that the rotary table is not rotated as far as would be necessary for the blocking position to be completely reached. On the other hand, this load can lead to a corresponding load transfer to a bearing supporting the drive shaft and/or a motor driving the drive shaft or a gear used in this context. These load-bearing components would thereby be additionally loaded, whereby service lives may be reduced.

In order to minimize the aforementioned risks associated with the pressing of the tooth flanks of the worm gear segment against the tooth flanks of the worm gear section, it is preferably provided that the drive shaft is aligned in such a way that the duplex toothing of the worm gear section has a play in both directions of rotation with respect to the toothing of the worm gear segment, which corresponds substantially to half a pitch of the internal tooth profile.

Preferably, the rotary table drive is adapted to drive the first rotary table and the second rotary table synchronously. In this way, a first workpiece clamped on the first clamping unit can be rotated synchronously with a second workpiece clamped on the second clamping unit.

Preferably, the workpiece pallet is designed with a counter-interface for coupling with an interface of a rotary plate of the machining center, wherein the clamping device is rotatable via the counter-interface by means of the rotary plate about the first axis of rotation. Preferably, counter-interfaces of different clamping devices are of the same design. In this way, different clamping devices can be connected to the same machining center, which are in particular each set up for clamping units which in turn are assigned to different workpiece geometries. In this way, the flexibility of the machining center can be increased.

It is further preferred that the first axis of rotation runs obliquely to the second axis of rotation and obliquely to the third axis of rotation. In particular, the first axis of rotation runs perpendicular to the second axis of rotation and perpendicular to the third axis of rotation.

A machining center according to the invention for machining workpieces has a workpiece positioning unit movable along an x-axis and along a y-axis running perpendicular to the x-axis, which is equipped with a clamping device as described above, and a tool slide device which can be equipped with a machining tool device in order to mechanically machine a first workpiece clamped by means of the first clamping unit and a second workpiece clamped by means of the second clamping unit in a machining zone, wherein the tool slide device has a drive spindle which can be driven to a rotational movement for providing drive energy for the machining tool device, wherein the tool slide device is linearly movable along a z-axis running perpendicular to the x-axis and perpendicular to the y-axis.

Such a machining center is also referred to as a double 5-axis machining center. The number of axes, i.e. five, refers to how many axes a relative movement can be effected between a workpiece clamped with the first clamping unit or second clamping unit and a machining tool assigned to this workpiece. In the workpiece according to the invention, the five axes are as follows: The x-axis corresponds to the first axis. The associated relative movement is the movement along the x-axis. The y-axis corresponds to the second axis. The associated relative movement is the movement along the y-axis. The z-axis corresponds to the third axis. The associated relative movement is the movement along the z-axis. The first axis of rotation corresponds to the fourth axis. The associated relative movement is the rotation about the first axis of rotation.

In addition, two fifth axes are provided with the second axis of rotation and the third axis of rotation. Therefore, the designation "double 5-axis" is used. The relative movements associated with the two fifth axes are the rotation about the second axis of rotation and the rotation about the third axis of rotation. Basically, 5-axis machining centers offer the advantage that a workpiece can be completely machined without reclamping, i.e. with or in one clamping. In the machining center according to the invention, two fifth axes are provided. This offers the advantage on the one hand that a higher utilization can be achieved. On the other hand, it has the advantage that two workpieces - one is clamped with the first clamping unit and another with the second clamping unit - can be machined in parallel with a single milling head.

Preferably, the tool slide device has a single slide. It is further preferred that the machining tool device has at least two machining tools, wherein a first machining tool is assigned to the first workpiece, and wherein a second machining tool is assigned to the second workpiece. In this way, both machining tools can be fed simultaneously to the respective workpiece by a tool feed movement to be carried out by means of the tool slide device along the z-axis. This feed is synchronous in this respect, whereby a high machining accuracy can be achieved.

Alternatively, the tool slide device has two slides, wherein each of the two slides carries a machining tool of the machining tool device, so that the machining tools can be fed independently of each other to the workpiece to be machined in each case. This allows the two workpieces to be machined with great flexibility.

### BRIEF DESCRIPTION OF THE DRAWINGS

Hereinafter, the invention will be explained in more detail with reference to the accompanying drawing, in which:

FIG. 1 shows a clamping device,

FIG. 2 shows the clamping device shown in FIG. 1 with a first clamping unit and a second clamping unit,

FIG. 3 shows the clamping device shown in FIG. 1 in a sectional view,

FIG. 4 shows the clamping device shown in FIGS. 1 and 3 in a further sectional view,

FIG. 5 shows a detail of the clamping device shown in FIGS. 1, 3 and 4,

FIG. 6 shows a further detail of the clamping device shown in FIGS. 1, 3 and 4,

FIG. 7 shows a further detail of a clamping device, and

FIG. 8 shows a machining center.

### DETAILED DESCRIPTION

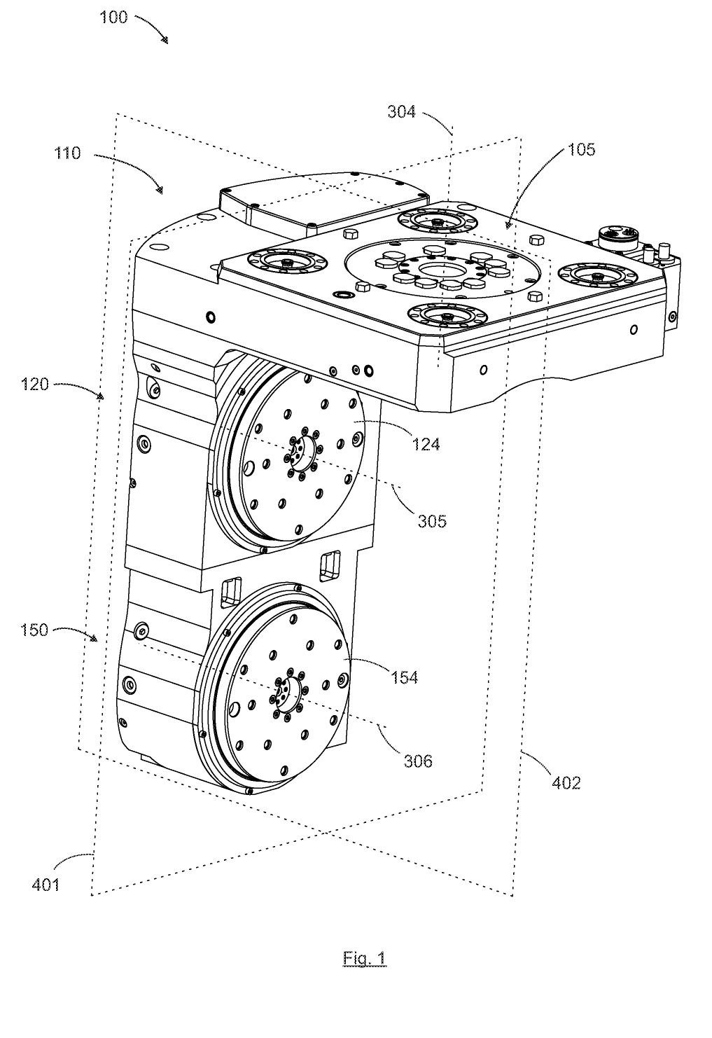

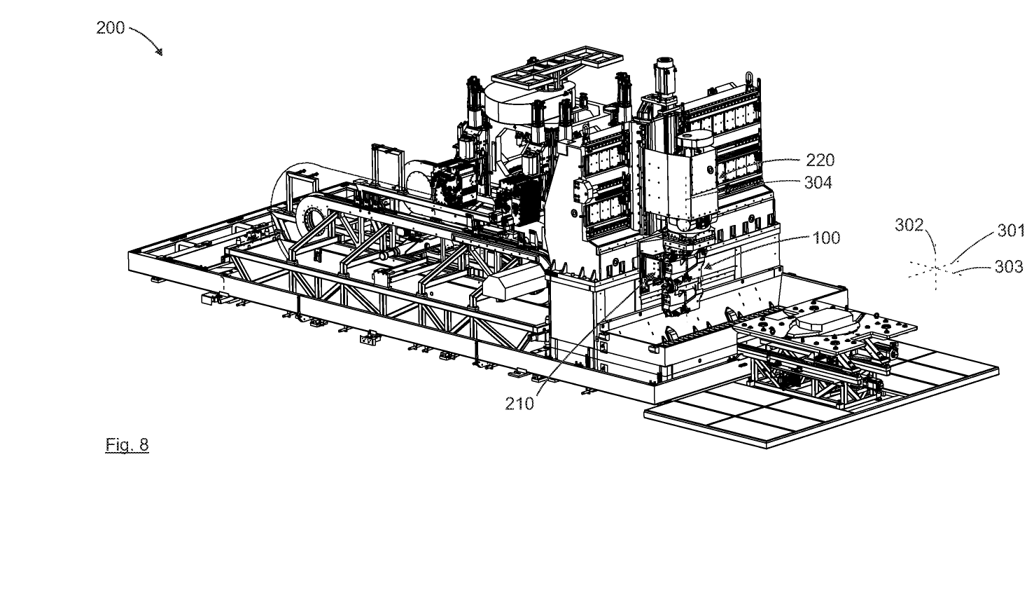

FIG. 1 shows a clamping device 100. The clamping device 100 has a workpiece pallet 110. Purely by way of example, the workpiece pallet 110 is designed with a counter-interface 105 for coupling with an interface of a rotary plate of a machining center 200 (cf. FIG. 8). The clamping device 100 is rotatable via the counter-interface 105 by means of the rotary plate about a first axis of rotation 304.

The clamping device 100 further has a first clamping unit receiving device 120 and a second clamping unit receiving device 150. Purely by way of example, the first clamping unit receiving device 120 is fastened directly to the workpiece pallet 110 and directly to the second clamping unit receiving device 150. The first clamping unit receiving device 120 has a first rotary table 124 which is rotatable about a second axis of rotation 305. The second clamping unit receiving device 150 has a second rotary table 154 which is rotatable about a third axis of rotation 306.

Purely by way of example, the second axis of rotation 305 is aligned perpendicular to the first axis of rotation 304 and the third axis of rotation 306 is aligned parallel to the second axis of rotation 305. Accordingly, the third axis of rotation 306 is also aligned perpendicular to the first axis of rotation 304.

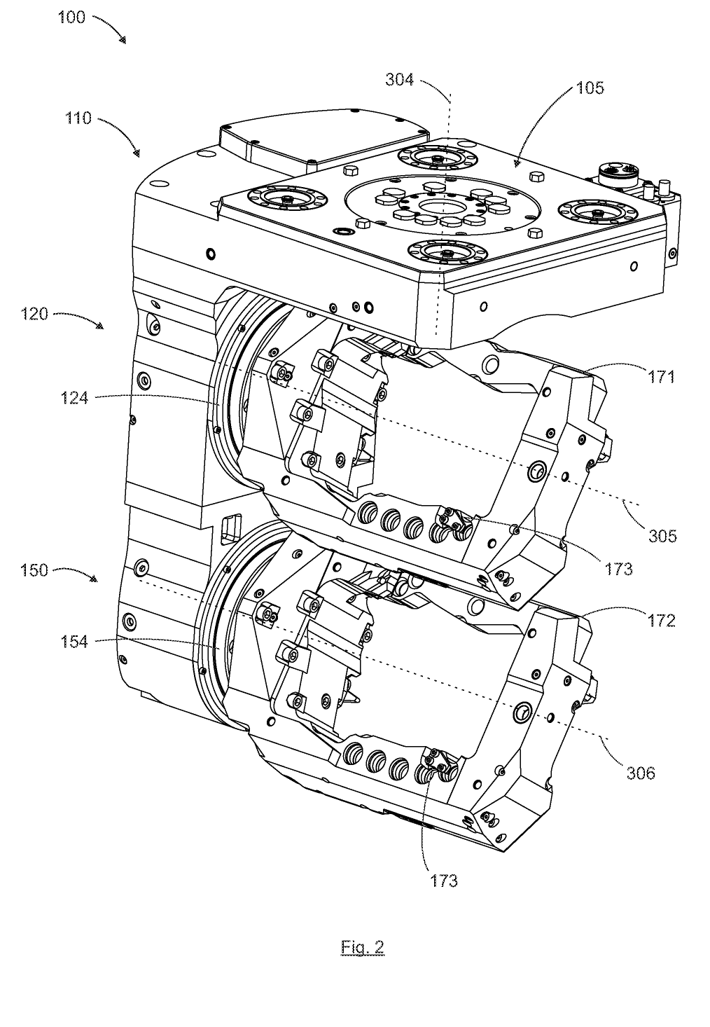

FIG. 2 shows the clamping device 100 shown in FIG. 1 with a first clamping unit 171 and a second clamping unit 172. The first clamping unit 171 is fastened to the first rotary table 124. The second clamping unit 172 is fastened to the second rotary table 154. The first clamping unit 171 and the second clamping unit 172 each have a clamping element 173. The clamping elements 173 are each movable between a release position and a clamping position in which a workpiece to be machined is clamped. A first workpiece can be clamped with the first clamping unit 171 and a second workpiece with the second clamping unit 172. In particular, the first clamping unit 171 and/or the second clamping unit 172 has a plurality of clamping elements 173.

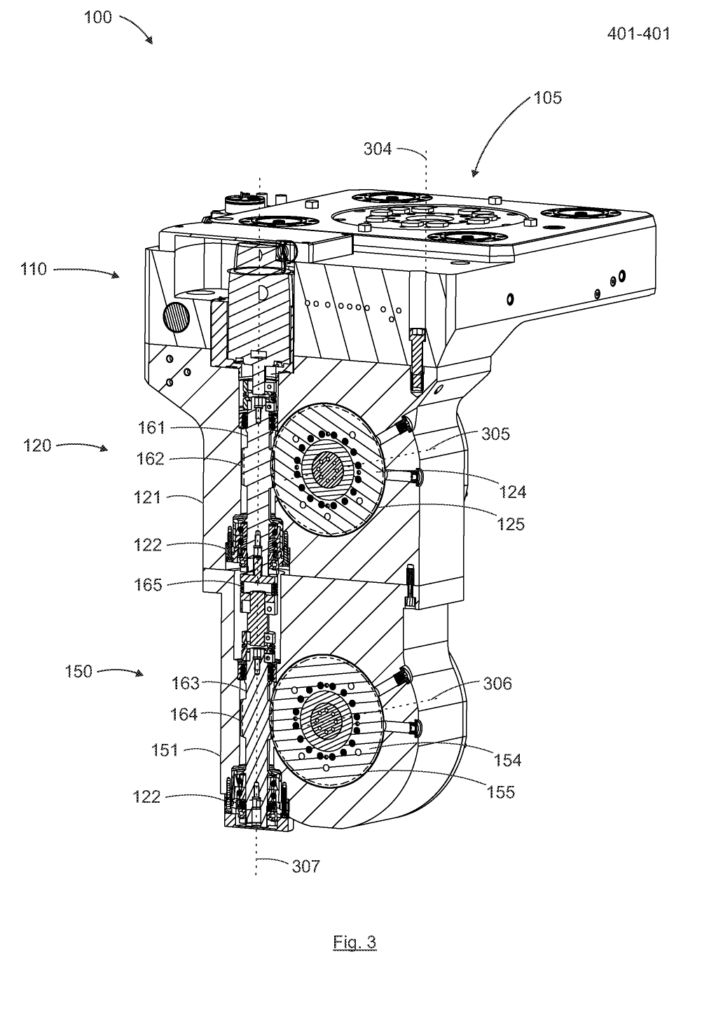

FIG. 3 shows the clamping device 100 shown in FIG. 1 in a sectional view 401-401. The section plane 401 corresponding to the sectional view 401-401 shown in FIG. 3 is shown in FIG. 1. The first clamping unit receiving device 120 has a first receiving housing 121. The first rotary table 124 is received in the first receiving housing 121. The second clamping unit receiving device 150 has a second receiving housing 151. The second rotary table 154 is received in the second receiving housing 151.

Purely by way of example, a first drive shaft 161 designed for the rotational drive of the first rotary table 124 and a second drive shaft 163 designed for the rotational drive of the second rotary table 154 are provided. Further by way of example, the first drive shaft 161 is connected to the second drive shaft 163 by means of a coupling 165, in particular by means of a bellows coupling as shown in FIG. 3. In particular, a longitudinal axis of the first drive shaft 161 and a longitudinal axis of the second drive shaft 163 run collinearly, namely along a common drive shaft longitudinal axis 307.

Purely by way of example, the first drive shaft 161 has a first worm gear section 162 and the second drive shaft 163 has a second worm gear section 164. Further by way of example, the first rotary table 124 has on a radial outer surface a first worm gear segment 125 and the second rotary table 154 has on a radial outer surface a second worm gear segment 155. The first worm gear segment 125 is in engagement with the first worm gear section 162 and the second worm gear segment 155 is in engagement with the second worm gear section 164.

Purely by way of example, a spacer ring 122 is arranged on the first receiving housing 121 and on the second receiving housing 151. With the spacer ring 122 arranged on the first receiving housing 121, an axial position of the first drive shaft 161, i.e. a position of the first drive shaft 161 with respect to the drive shaft longitudinal axis 307, can be adjusted. This is particularly advantageous if the first worm gear section 162 and the second worm gear section 164 each have a duplex toothing.

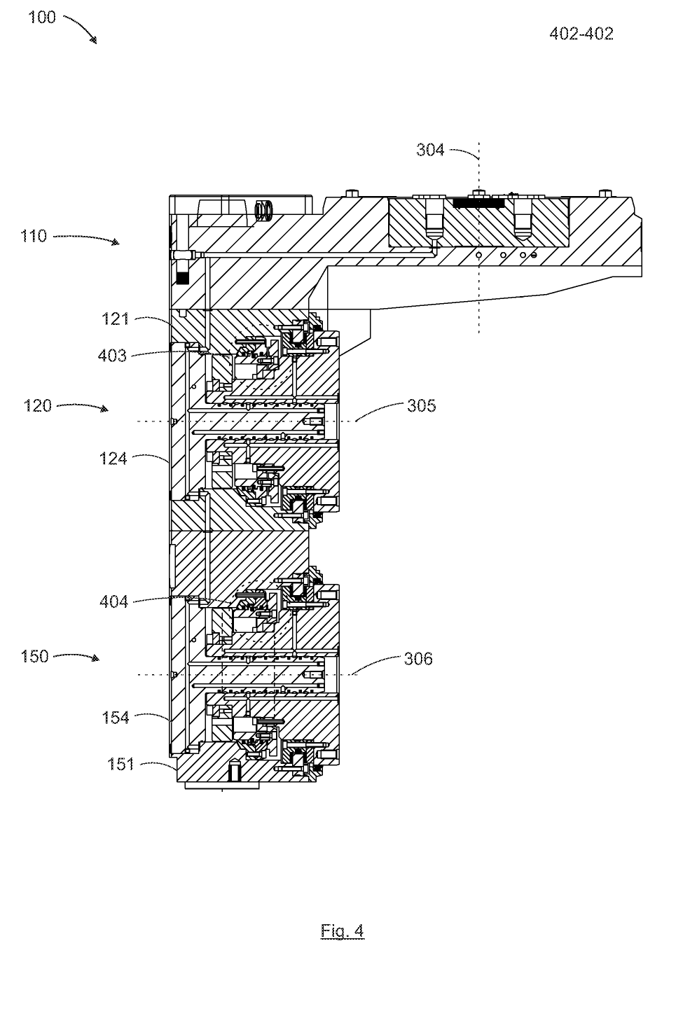

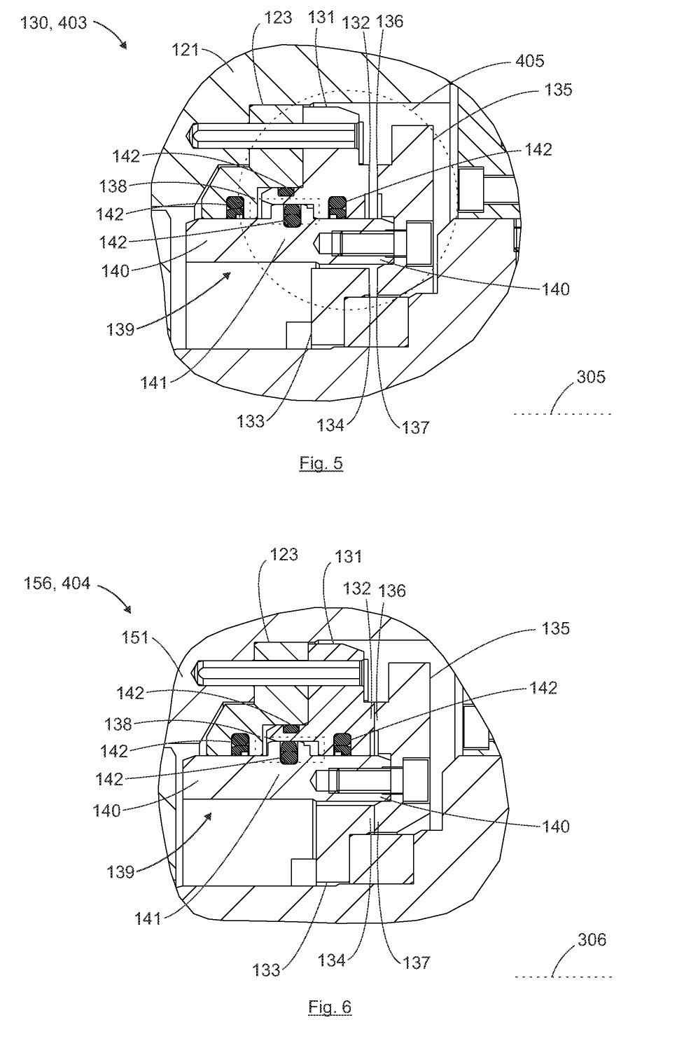

FIG. 4 shows the clamping device 100 shown in FIGS. 1 and 3 in a further sectional view 402-402. The section plane 402 corresponding to the sectional view 402-402 shown in FIG. 4 is shown in FIG. 1. FIGS. 5 and 6 each show a detail 403, 404 of the clamping device 100 shown in FIGS. 1, 3 and 4. The position of the details 403, 404 is indicated in FIG. 4. The first clamping unit receiving device 120 has a first blocking device 130, a section of which is shown in FIG. 5. The second clamping unit receiving device 150 has a second blocking device 156, a section of which is shown in FIG. 6.

Purely by way of example, the first blocking device 130 and the second blocking device 156 are of the same design. Accordingly, what is described below in connection with the first blocking device 130 applies in the same way to the second blocking device 156. The first blocking device 130 has a first coupling element designed as an outer coupling element 131 and the second blocking device 156 has a second coupling element also designed as an outer coupling element 131. The individual outer coupling elements 131 are each fixedly connected to the corresponding receiving housing 121, 151.

The blocking device 130, 156 further has an inner coupling element 133 and a blocking element 135. Purely by way of example, the outer coupling element 131, the inner coupling element 133 and the blocking element 135 of a single blocking device 130, 156 are arranged concentrically, in particular concentrically with respect to the axis of rotation 305, 306 assigned to the corresponding rotary table 124, 154. The blocking element 135 is movable by means of an engagement movement and a disengagement movement aligned opposite to the engagement movement along a disengagement axis which is purely exemplarily aligned parallel to the respective axis of rotation 305, 306. By means of the purely exemplarily leftward-directed engagement movement, the respective rotary table 124, 154 can be moved into a blocking position. By means of the purely exemplarily rightward-directed disengagement movement, the respective rotary table 124, 154 can be moved into a release position.

In the blocking position, which is shown in FIG. 6, the respective rotary table 124, 154 is non-rotatably coupled to the respective receiving housing 121, 151 with respect to the corresponding axis of rotation 305, 306. In the release position, which is shown in FIG. 5, the respective rotary table 124, 154 is rotatable relative to the respective receiving housing 121, 151 with respect to the corresponding axis of rotation 305, 306.

The blocking element 135 has a first bridge tooth profile 136 designed as an axial toothing. The outer coupling element 131 has an external tooth profile 132 also designed as an axial toothing. The blocking element 135 further has a second bridge tooth profile 137 designed as an axial toothing. The inner coupling element 133 has an internal tooth profile 134 designed as an axial toothing. In the blocking position (cf. FIG. 6), the first bridge tooth profile 136 rests in a form-fitting manner on the external tooth profile 132 and the second bridge tooth profile 137 rests in a form-fitting manner on the internal tooth profile 134. This means that in the blocking position, the tooth profile pair formed by the first bridge tooth profile 136 and the external tooth profile 132 and the tooth profile pair formed by the second bridge tooth profile 137 and the internal tooth profile 134 are simultaneously in engagement. In the release position (cf. FIG. 5), the first bridge tooth profile 136 is spaced from the external tooth profile 132 and the second bridge tooth profile 137 is spaced from the internal tooth profile 134. This means that the aforementioned tooth profile pairs are simultaneously out of engagement.

Purely by way of example, the outer coupling element 131, the inner coupling element 133 and the blocking element 135 are each of ring-like design and further by way of example are arranged concentrically with respect to the respective axis of rotation 305, 306.

Purely by way of example, the first blocking device 130 and the second blocking device 156 each have a hydraulically acting adjusting device which has a piston element 139 connected to the blocking element 135. The engagement movement and the disengagement movement can be carried out by means of the adjusting device. In particular, the piston element 139 is screwed to the blocking element 135 as shown in FIGS. 5 and 6. Further by way of example, a cylinder 138 is provided which is formed by an intermediate ring 123 arranged between the outer coupling element 131 and the respective receiving housing 121, 151, the outer coupling element 131 and two spaced-apart end sections 140 of the piston element 139.

Purely by way of example, the piston element 139 has a central section 141 arranged between the two end sections 140, which projects in the radial direction into an interior of the cylinder 138. The central section 141 forms in functional terms the actual piston, i.e. the component moving in the cylinder 138. Further by way of example, seals 142 are provided in the area of the cylinder 138, which seal the interior of the cylinder 138 from the outside. For example, a seal 142 is fixed to the intermediate ring 123, two seals 142 are fixed to the outer coupling element 131 and a seal 142 is fixed to the central section 141. In particular, the seals 142 are each designed as ring-like O-rings.

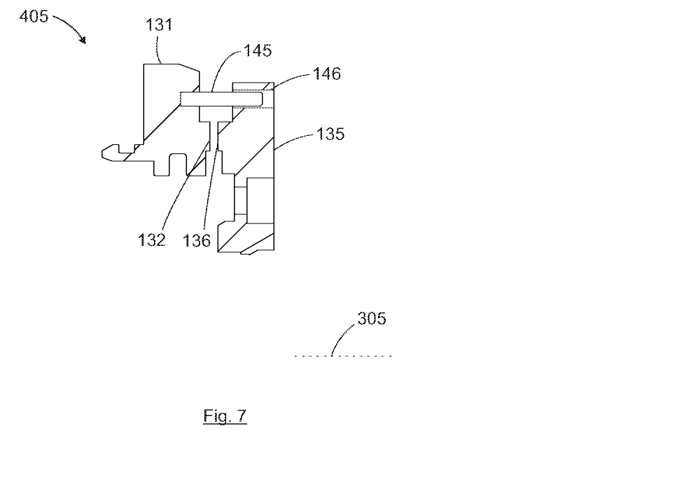

FIG. 7 shows a further detail 405 of a clamping device 100. The position of the detail 405 is indicated in FIG. 5. Purely by way of example, the blocking device 130, 156 has a play limiting device with a limiting pin 145 fastened to the outer coupling element 131 and a pin holder 146 provided on the blocking element 135. A clearance fit is formed between the limiting pin 145 and the pin holder 146. With the play limiting device, a play between the outer coupling element 131 and the blocking element 135 is limited in the release position with respect to a rotation about the respective axis of rotation 305, 306. As shown in FIG. 7, the limiting pin 145 is also received in the pin holder 146 when the respective rotary table 124, 154 is in the release position, which can be recognized by the fact that the external tooth profile 132 is spaced from the first bridge tooth profile 136.

FIG. 8 shows a machining center 200. The machining center 200 has a workpiece positioning unit 220 movable along an x-axis 301 and along a y-axis 302 running perpendicular to the x-axis 301. The workpiece positioning unit 220 is equipped with the clamping device 100. The machining center 200 further has a tool slide device 210 which is linearly movable along a z-axis 303 running perpendicular to the x-axis 301 and perpendicular to the y-axis 302. Purely by way of example, the first axis of rotation 304 is aligned parallel to the y-axis 302.

1. A clamping device for a machining center for the mechanical machining of workpieces, comprising:
a workpiece pallet for coupling with the machining center, such that the clamping device is rotatable about a first axis of rotation in a coupled state of use, and
wherein the clamping device has a first clamping unit receiving device and a second clamping unit receiving device which are connected to the workpiece pallet, wherein the first clamping unit receiving device has a first receiving housing and a first rotary table received in the first receiving housing, to which a first clamping unit for receiving and clamping a first workpiece can be fastened, wherein the second clamping unit receiving device has a second receiving housing and a second rotary table received in the second receiving housing, to which a second clamping unit for receiving and clamping a second workpiece can be fastened,
wherein the clamping device has a rotary table drive which is adapted to rotate the first rotary table about a second axis of rotation and to rotate the second rotary table about a third axis of rotation, wherein the first clamping unit receiving device has a first blocking device with a first coupling element fixed to the first clamping unit receiving device and a first blocking element movable relative to the first coupling element, wherein the first rotary table can be moved by means of a first engagement movement to be carried out with the first blocking element into a first blocking position in which the first rotary table is non-rotatably coupled to the first receiving housing with respect to the second axis of rotation, and by means of a first disengagement movement to be carried out with the first blocking element into a first release position in which the first rotary table is rotatable relative to the first receiving housing with respect to the second axis of rotation, wherein the second clamping unit receiving device has a second blocking device with a second coupling element fixed to the second clamping unit receiving device and a second blocking element movable relative to the second coupling element, wherein the second rotary table can be moved by means of a second engagement movement to be carried out with the second blocking element into a second blocking position in which the second rotary table is non-rotatably coupled to the second receiving housing with respect to the third axis of rotation, and by means of a second disengagement movement to be carried out with the second blocking element into a second release position in which the second rotary table is rotatable relative to the second receiving housing with respect to the third axis of rotation.

2. The clamping device according to claim 1, wherein in at least one of the blocking devices the coupling element is designed as an outer coupling element fixedly connected to the receiving housing, and that at least one of the blocking devices has an inner coupling element fixedly connected to the first rotary table or the second rotary table, wherein in the blocking position the outer coupling element is positively connected to the inner coupling element with respect to a rotation about the second axis of rotation or the third axis of rotation.

3. The clamping device according to claim 2, wherein the outer coupling element has an external tooth profile and that the inner coupling element has an internal tooth profile which is in engagement with the external tooth profile in the blocking position.

4. The clamping device according to claim 3, wherein the external tooth profile and the internal tooth profile are each designed as an axial toothing.

5. The clamping device according to claim 3, wherein in at least one of the blocking devices the blocking element has a first bridge tooth profile, in particular designed as an axial toothing, which rests in a form-fitting manner on the external tooth profile in the blocking position, and has a second bridge tooth profile, which rests in a form-fitting manner on the internal tooth profile in the blocking position, wherein the blocking element is adapted to carry out the engagement movement and the disengagement movement along a disengagement axis, wherein the outer coupling element, the inner coupling element and the blocking element are each of ring-like design.

6. The clamping device according to claim 5, wherein the external tooth profile and the first bridge tooth profile as well as the internal tooth profile and the second bridge tooth profile each form a mating toothing.

7. The clamping device according to claim 5, wherein at least one of the blocking devices has an adjusting device which has a piston element connected to the blocking element and received in a cylinder, wherein the adjusting device is designed to act hydraulically.

8. The clamping device according to one of claim 5, wherein at least one of the blocking devices has a play limiting device which limits a play between the outer coupling element and the blocking element in the release position with respect to a rotation about the second axis of rotation or third axis of rotation.

9. The clamping device according to claim 8, wherein the play limiting device has a limiting pin, and a pin holder, wherein a clearance fit is formed between the limiting pin and the pin holder, wherein the limiting pin is received in the pin holder when the rotary table is in the release position.

10. The clamping device according to claim 1, wherein the rotary table drive has a first drive shaft designed for the rotational drive of the first rotary table and a second drive shaft designed for the rotational drive of the second rotary table.

11. The clamping device according to claim 10, wherein at least one of the drive shafts has a worm gear section, wherein the rotary table has on a radial outer surface a worm gear segment which is in engagement with the worm gear section.

12. The clamping device according to claim 11, wherein at least one of the worm gear sections has a duplex toothing, wherein at least one spacer ring is arranged on at least one receiving housing in order to adjust an axial position of the drive shaft with respect to the receiving housing.

13. The clamping device according to claim 12, wherein the rotary table drive is adapted to drive the first rotary table and the second rotary table synchronously.

14. The clamping device according to claim 1, wherein the workpiece pallet is designed with a counter-interface for coupling with an interface of a rotary plate of the machining center, wherein the clamping device is rotatable via the counter-interface by means of the rotary plate about the first axis of rotation.

15. A machining center for machining workpieces with a workpiece positioning unit movable along an x-axis and along a y-axis running perpendicular to the x-axis, which is equipped with a clamping device according to claim 1, and with a tool slide device which can be equipped with a machining tool device in order to mechanically machine a first workpiece clamped by means of the first clamping unit and a second workpiece clamped by means of the second clamping unit in a machining zone, wherein the tool slide device has a drive spindle which can be driven to a rotational movement for providing drive energy for the machining tool device, wherein the tool slide device is linearly movable along a z-axis running perpendicular to the x-axis and perpendicular to the y-axis.
Fehler! Textmarke nicht definiert.
